(19) United States
(12) Patent Application Publication
(10) Pub. No.: US 2004/0219911 A1
(43) Pub. Date: Nov. 4, 2004

(54) Virtual communications assistance for law enforcement act (CALEA) device

(76) Inventors: Farrokh Mohammadzadeh Kouchri, Boca Raton, FL (US); Bizhan Karimi-Cherkandi, Boca Raton, FL (US)

Correspondence Address: Elsa Keller, Siemens Corporation, Intellectual Property Department, 170 Wood Avenue South, Iselin, NJ, 08830, US

(21) Appl. No.: 10/809,618

(22) Filed: Mar. 25, 2004

Related U.S. Application Data
(60) Provisional application No. 60/457,347, filed on Mar. 25, 2003.

(30) Foreign Application Priority Data
Aug. 14, 2003 (GB) 0319050.1
Aug. 14, 2003 (GB) 0319051.9
Aug. 14, 2003 (GB) 0319048.5

(51) Int. Cl. H04Q 7/20

(52) U.S. Cl. 455/423; 455/445

(57) ABSTRACT

Law enforcement regulation of calls in a telecommunications network is provided. A law enforcement application executes commands that effect the law enforcement regulation. A primary rate interface (PRI) coupled to the law enforcement application redirects calls to be regulated by law enforcement regulation. A method for effecting a law enforcement regulation in a telecommunications network provides a law enforcement application is that regulates calls and a primary rate interface (PRI) for redirecting the calls to be regulated by law enforcement regulation. A telephony protocol encapsulates the PRI for transporting signals relating to the call over a packetized network.

### BACKGROUND

1. Field of the Invention

The present invention relates to a Communications Assistance for Law Enforcement Act (CALEA) device and, more particularly, to facilitating an Advanced Intelligent Network (AIN)-CALEA in VoIP network to capture call data and call content using a virtual primary rate interface (PRI) connection.

2. Related Information

The purpose of this invention is to provide lawful intercept of calls. In these modern times, it is unfortunate that public communications have become a conduit by which unlawful activities coordinate. The need to address this problem became apparent with the implementation of digital technology and wireless services, which have almost outpaced the ability of law enforcement officials to conduct authorized electronic surveillance.

In order to combat this, the US Congress in 1994 passed the Communications Assistance for Law Enforcement Act (CALEA), which provides that carriers shall implement procedures and equipment to assist law enforcement agencies, primarily the Federal Communications Commission, to carry out their lawful interception and monitoring of telecommunication calls. Specifically, CALEA requires telecommunications Carriers to ensure that their equipment, facilities, and services are able to comply with authorized electronic surveillance.

From the carrier perspective, the CALEA implementations are burdensome. The entire cost for implementing these provisions are left up to the Carriers, leaving the carriers holding the bag. Thus, Carriers need to comply with these enforcement provisions with the least amount of cost burden to their overhead.

Moreover, implementing the CALEA provisions for the various types of networks is difficult to say the least. In the packet world, for example, redirecting calls is not a trivial undertaking, especially when one considers that packets are only portions of data calls that are whizzing around the network universe.

It would be an advantage if one could redirect calls within the packet world particularly for CALEA applications. This would allow the CALEA application to be placed anywhere.

What is needed is a CALEA application that is cost effective for carriers to implement. What is further needed is a means by which carriers can redirect packets. It would be advantageous to be able to place the CALEA device anywhere in the network. Heretofore, there has not been provided any such means that resolves these problems.

### OBJECTS & SUMMARY OF THE INVENTION

An object of the present invention is to provide a virtual CALEA device.

An object of the present invention is to provide a virtual PRI facilitating an Advanced Intelligent Network (AIN) that implements CALEA.

Yet another object of the invention is to redirect packets in a packet network.

Still another object of the invention is to place the CALEA device anywhere in the network.

In accordance with the present invention there is provided an apparatus for effecting a governmental regulation for monitoring a call in a telecommunications network. An application for executing commands that effect the governmental regulation. A primary rate interface (PRI) is coupled to the application for redirecting calls to be monitored according to the governmental regulation. A telephony protocol encapsulating the PRI for transporting signals relating to the call over a packetized network.

### BRIEF DESCRIPTION OF THE DRAWINGS

The following figures illustrate the present invention in particular detail, and it shall be considered that the figures are merely examples:

FIG. 1 is a block diagram illustrating SIGTRAN encapsulating PRI;

FIG. 2 is a block diagram of the protocol stack of the present invention; and

FIG. 3 is a system diagram of the present invention.

### DETAILED DESCRIPTION OF THE PREFERRED EMBODIMENTS

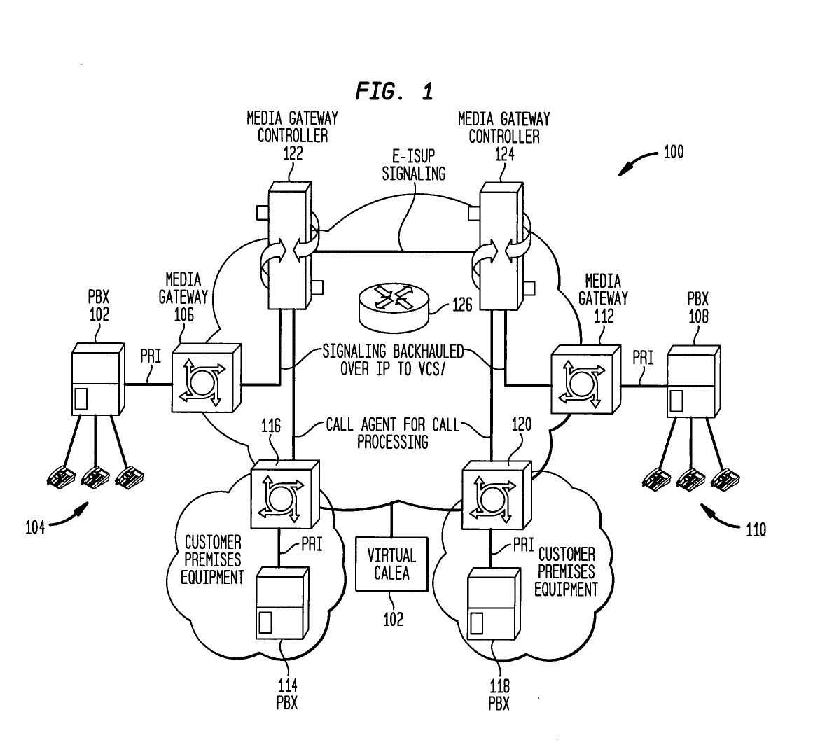

FIG. 1 shows how a typical network 100 with SIGTRAN PRI (Signaling Transport Primary Rate Interface) incorporated therein is modified to include the virtual CALEA device 102 of the present invention.

As shown in the figure, there are a number of PBX (private branch exchange) telephone systems connected through various means, each PBX within an enterprise for switching calls between enterprise users on local lines while allowing all users to share a certain number of external phone lines. The main purpose of this configuration is to save the cost of requiring a line for each user to the telephone company's central office.

There is shown, for example, PBX 102 for connecting the individual users 104 through a media gateway 106 that uses a Primary Rate Interface (PRI) to channel calls through the network 100. Similarly, a PBX 108 couples calls from users 110 through a media gateway 112.

A PBX 114 encapsulates PRI using SIGTRAN in the form of customer premises equipment and another media gateway 116. Similarly, another PBX 118 encapsulates PRI using SIGTRAN and is connected to the network 100 through a media gateway 120.

Media gateway controllers 122, 124 control the media gateways 106, 112, 116 and 120 and exchange the data from the PBX networks via a router 126 according to, for example, Integrated Services Digital Network User Part (E-ISUP) signaling.

A brief word regarding SIGTRAN is perhaps in order. SIGTRAN is the standard telephony protocol used to transport Signaling System 7 (SS7) signals over the Internet. SS7 signals consist of special commands for handling a telephone call. Internet telephony uses the Internet Protocol's packet-switched connections to exchange voice, fax, and other forms of information that have traditionally been carried over the dedicated circuit switched connections of the public switched telephone network (PSTN).

Calls transmitted over the Internet travel as packets of data on shared lines, avoiding the tolls of PSTN. A telephone company switch transmits SS7 signals to a signaling gateway. The gateway, in turn, converts the signals into SIGTRAN packets for transmission over IP to either the next signaling gateway or, if the packet destination is not another PSTN, to a soft switch.

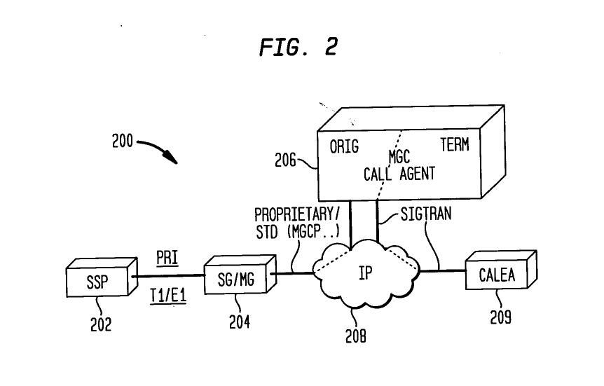

FIG. 2 shows the protocol stack 200, a hierarchy of protocols which work together to provide the services on a communications network. The SIGTRAN protocol is made up of several such components. Its protocol stack comprises a standard IP, a common signaling transport protocol (used to ensure that the data required for signaling is delivered properly), such as the Stream Control Transport Protocol (SCTP), and an adaptation protocol that supports “primitives” (a basic interface or segment of code that can be used to build more sophisticated program elements or interfaces) that are required by another protocol.

For this invention, the protocol stack is reflected in FIG. 2. The Service Switching Point (SSP) 202 is the switch where the surveillance subject line resides. The SSP is coupled to the Signaling and Media Gateway (SG/MG) component 204 via PRI (physically T1/E1). In addition, the SG/MG component 204 is coupled to the media gateway controller (MGC) call agent 206 via IP-signaling protocol (standard or proprietary). The MGC call agent 206 is coupled to the CALEA device 209 over IP network 208 using SIGTRAN-PRI protocol. The physical connections of Signaling and Media Gateway (SG/MG) 204, media gateway controller (MGC) call agent 206 and CALEA device 209 to the IP-network 208 are well-known within the art of telecommunications engineering.

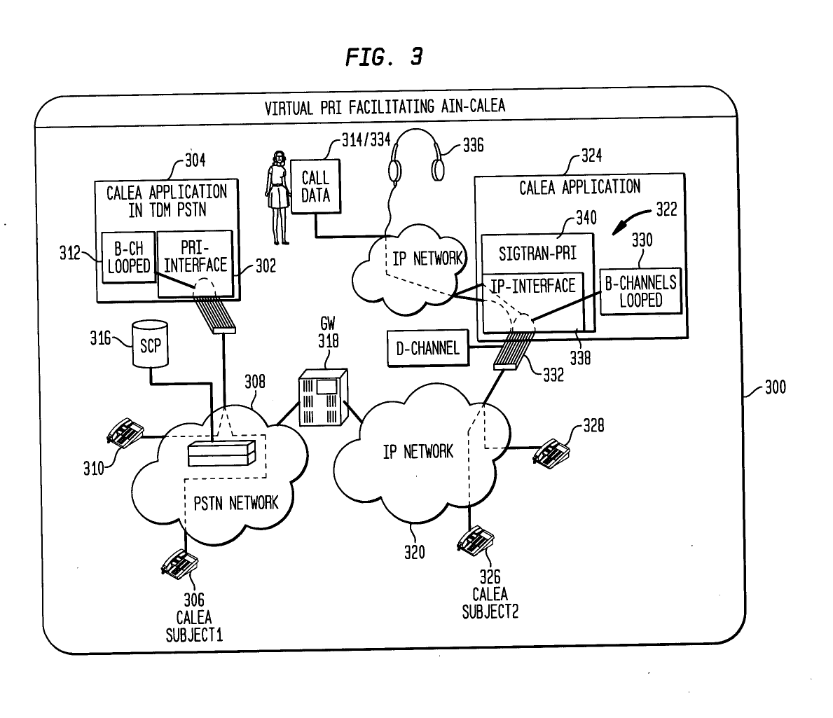

In FIG. 3, there is shown a virtual primary rate interface (PRI) device encapsulated by SIGTRAN for facilitating AIN-CALEA 300. The present invention is advantageous because it allows CALEA applications to interact easily with a packet network, yet while maintaining the Time Division Multiplex (TDM) infrastructure of the resident network. By encapsulating the PRI in a device which has SIGTRANPRI-Capablity, the invention provides a virtual interface by which CALEA application can be implemented in the IP network. By encapsulating PRI-protocol (layer 2 & layer 3) in the packet world the physical connection becomes virtual.

PRI is an important protocol for large ISDN users. In comparison with the Basic Rate Interface (BRI), the other ISDN protocol which is intended for personal or small enterprises, PRI is intended for use with high speed connections. In general, both BRI and PRI include a number of B-channels and a D-channel. Each B-Channel carries data, voice, and other services. The D-Channel carries control and signaling information and data.

However, with PRIs 23 B-channels and one 64 Kpbs D-channel using a T-1 line or 30 B-channels and 1 D-channel using an E1/T1 line, PRI is the hands down winner for commercial applications. For that matter, a Primary Rate Interface user on a T-1 line can have up to 1.544 Mbps service or up to 2.048 Mbps service on an E1 line. The 23 (or 30) B-channels can be used flexibly and reassigned when necessary to meet special needs such as videoconferences. The Primary Rate user may be hooked up directly to the telephone company central office.

In a given ISDN connection, such as PRI, the ISDN protocol demands that each end of the connection assumes one of the two roles of communication. The roles are defined as network-side and user-side. Based on the role, the two ends perform different tasks in particular with regards to authentication of the origination (calling) or termination (called) party/number. In either case, both the calling number and the called numbers are included within the calling information as part of the set-up of an ISDN phone call. This information is provided to the switches as part of the call routing and authentication, and in the case of the called party, the calling party's number is typically displayed within the called party's ISDN device.

If the role of network-side is assumed, the calling party's number (but not the called party's number) may be subject to authentication, and the call may be rejected if the authentication is not provided. The authenticated call shall be routed or terminated based on the called number. If the role of user-side is assumed, then authentication of the calling number is not typically performed and the call is routed or terminated based on the called number.

As one example, this authentication is illustrated in a configuration where a PBX is connected to a PSTN. Calls originated from PBX (assuming user-side) towards PSTN (assuming network-side) are mainly subject of authentication in the PSTN switch based on the calling number. This is done based on the fact that PSTN has a database of all subscribers (or groups of subscribers) within the PBX. A call with an unauthorized calling number will be rejected. If the calling number is not presented at the stage of initiation, then PSTN may insert a default calling number defined for that PBX. In a TDM environment, there are situations where two PSTNs may wish to connect to each other through a PRI interface. In this case, each shall accept one of the two roles (network-side or user-side).

The advantage of the PRI access is its capability to be set to carry any calling ID and called ID and the network will accept the delivery of the call. This is different than other access types such as a regular telephone. By carrying any calling ID and called ID, the CALEA subject does not sense the redirection of the call. This assumes a special configuration in the switch to recognize the PRI-Box as a network-side PRI. This provides the CALEA-device the capability to originate a call with any calling number.

As shown in FIG. 3, a PRI-Device 302 is provided to assist a CALEA application 304. When the CALEA subject 306 initiates a call, for example, through a network 308 to a destination 310, the call is forwarded by the switch (eg.g using AIN termination_attempt trigger or plain call forwarding feature) to the PRI device where the call is managed by the PRI device 302. The network 308 may be any type of network, including A PSTN or IP network. Each call offered to this device uses the B-channel 312. That is, the voice is conveyed over the B-channel 312 and is captured. The call data is conveyed on the D-channel 314, for example, User-User Information (UUI) as supplementary data.

Using the call data, the invention originates a call and loops the B-Channel 312 to the destination 310. The call data 314 is forwarded by the PRI device 302 to the CALEA operator 316 and the voice signal may be forwarded to a remote location (not shown) which may terminate in a terminal, such as a recorder or head set for example.

The network 308 determines whether to forward the call to the CALEA device with the assistance, for example, of a Service Control Point (SCP) 316.

The SCP 316 determines how to handle the traffic, i.e., whether to redirect the call to the CALEA device 304, also called a CALEA facility, that provides the CALEA functionality.

The PRI device 302 in one aspect may be a PRI card. The PRI card may be installed in a computer, such as a personal computer (PC), where the CALEA application 304 is running. Further, the PRI device 302 may be connected through a gateway 318 to another network 320, such as an IP network.

A virtual PRI-Software-protocol-Application 322 is further provided to assist a CALEA application 324. When a second CALEA subject 326 initiates a call, for example, through the network 320 to a destination 328, the call is managed by the PRI device 322.

The network 320 may be any type of network, including A PSTN or IP network. Each call offered to this device uses the B-channel 330. That is, the voice is conveyed over the B-channel 330 and is captured. The call data is conveyed on the D-channel 332, for example, User-User Information (UUI) as supplementary data, calling party ID, called party ID, nature of address . . . etc.

Using the call data, the invention originates a call and loops the B-Channel 332 to the destination 328. The call data 334 is forwarded by the PRI device 322 to a CALEA operator and the voice signal may be forwarded to a remote location 336 which may terminate in a terminal, such as a recorder or head set for example.

The network 320 determines whether to forward the call to the CALEA device with the assistance, for example, of a Service Control Point (SCP). The SCP determines how to handle the traffic, i.e., whether to redirect the call to the CALEA device 324, also called a CALEA facility, that provides the CALEA functionality.

The PRI-Software-protocol-Application 322 may be installed in a computer, such as a personal computer (PC), where the CALEA application 324 is running. Further, the PRI-Software-protocol-Application 322 may be connected through a gateway 318 to another network 308.

In the present invention, the virtual PRI-Software-protocol-Application 322 is composed of an IP-Interface encapsulated in a SIGTRAN (software component) 340. The primary rate access (PRI) interface is provided in the TDM world. To move forward to a packet network, we need additional protocol (SIGTRAN) to be able to use a PRI interface inside a packet network. The whole sense of having a virtual CALEA device in a packet network is to provide lawful intercept for packet calls without having to leave the packet world. The object of this invention is not necessarily the feature richness of such device, but nevertheless is worth mentioning that realization of such device may ease realization of many features. For example, the benefit of using the virtual CALEA device is depicted in FIG. 1. As will be appreciated therefrom, the CALEA premise could be realized anywhere inside the packet network, where the law enforcement premises LEI-CPE could be located anywhere within the packet world and based on the subject, intercepted data (or call content) can be forwarded to a specific LEI-CPE (e.g. a LEI-CPE may be a SIP phone).

While the present invention has been described with reference to a CALEA device, the invention is not limited to a particular ratification of CALEA, and covers assisting law enforcement regulation, either government agency or statutory promulgated, of communications in general.

The invention also relates to a method 200 for establishing a CALEA functionality using a PRI device as shown in FIG. 2. In step 202, the SCP decides whether CALEA is to be applied to the call, if yes then the call is redirected toward the CALEA device. In step 204, the call is converted and forwarded to IP-network. In step 206, the call is converted and embedded in SIGTRAN protocol and delivered to 209 where the call data is passed over the D-Channel and the process ends.

The present invention has, thus, been described with reference to the detailed figures, and it shall be appreciated that the invention is not so limited to the particular aspects or embodiments shown, but encompasses the broader invention contemplated herein.

We claim:

1. An apparatus for effecting a governmental regulation for monitoring a call in a telecommunications network, comprising:
an application for executing commands that effect the governmental regulation;
a primary rate interface (PRI) coupled to the application for redirecting calls to be monitored according to the governmental regulation; and
a telephony protocol encapsulating the PRI for transporting signals relating to the call over a packetized network.

2. The apparatus of claim 1, wherein the telephony protocol is Signaling Transport SIGTRAN.

3. The apparatus of claim 1, wherein the governmental regulation is established by the Communications Assistance for Law Enforcement Act (CALEA).

4. The apparatus of claim 1, wherein the PRI includes a B-Channel that conveys voice signals and the PRI loops the voice signals to a termination point.

5. The apparatus of claim 1, wherein the PRI includes a D-Channel that conveys call data and the PRI forwards the call data to an operator.

6. The apparatus of claim 1, wherein the PRI is a personal computer (PC) card.

7. The apparatus of claim 1, further comprising a Service Control Point that determines whether a particular call is to be regulated.

8. The apparatus of claim 1, wherein the network is a public switched telephone network PSTN.

9. The apparatus of claim 1, wherein network is an Internet Protocol (IP) network.

10. A method for effecting a governmental regulation for monitoring a call in a telecommunications network, comprising the steps of:
providing an application that regulates calls in accordance with the governmental regulation;
providing a primary rate interface (PRI) for redirecting the calls to be regulated by law enforcement regulation; and
transporting signals relating to the call over a packetized network using a transport protocol.

11. The method of claim 10, wherein the step of transporting is based on signaling transport SIGTRAN.

12. The method of claim 10, wherein the governmental regulation is compliant with Communications Assistance Law Enforcement Act.
